(19) United States
(12) Patent Application Publication
(10) Pub. No.: US 2026/0337503 A1
(43) Pub. Date: Oct. 29, 2026

(54) ZERO-CARBON-EMISSION COAL POWER-GENERATION SYSTEM CAPABLE OF SELF-GENERATING CO2 WORKING MEDIUM AND POWER-GENERATION METHOD THEREFOR

(71) Applicant: SHENZHEN UNIVERSITY, Shenzhen (CN)

(72) Inventors: Heping XIE, Shenzhen (CN); Shuo ZHAI, Shenzhen (CN); Geng XUE, Shenzhen (CN); Jianhui SHEN, Shenzhen (CN); Rubao ZHAO, Shenzhen (CN); Junyu CAI, Shenzhen (CN); Yunpeng ZHEN, Shenzhen (CN)

(73) Assignee: SHENZHEN UNIVERSITY, Shenzhen (CN)

(21) Appl. No.: 19/529,228

(22) Filed: Feb. 4, 2026

(30) Foreign Application Priority Data
Apr. 25, 2025 (CN) 202510528821.0

(51) Int. Cl. C10J 3/48; C10J 3/82

(52) U.S. Cl. CPC C10J 3/48; C10J 3/82; C10J 2200/12; C10J 2300/0969; C10J 2300/1671; C10J 2300/1815; C10J 2300/1861

(57) ABSTRACT

A zero-carbon-emission coal power-generation system capable of self-generating CO₂ working medium and a power-generation method therefor are provided. The power-generation system includes a coal gasification reactor, a desulfurization absorption tower, a condensation tank, a pressure swing adsorption device, a CO storage tank, a cell device, and a first connection pipeline. The coal gasification reactor is provided with a pulverized-coal inlet and a CO₂ inlet, the cell device includes a load, a cathode chamber, an anode chamber, and an electrolyte layer arranged between the cathode chamber and the anode chamber, and the cell device is provided with an air inlet and a tail-gas outlet. The first connection pipeline connects the tail-gas outlet of the cell device with the coal gasification reactor, and is configured to circulate a tail gas generated in the cell device to the coal gasification reactor.

### CROSS-REFERENCE TO RELATED APPLICATION(S)

The present application claims priority to Chinese Patent Application No. 202510528821.0, filed on Apr. 25, 2025, and the content of all of which is incorporated by reference in the present application.

### FIELD

The present disclosure relates to the technical field of power generation, in particular to a zero-carbon-emission coal power-generation system capable of self-generating CO₂ working medium and a power-generation method therefor.

### BACKGROUND

A general process of IGFC (integrated gasification fuel cell) is that coal (or natural gas, biomass, etc.) is gasified to generate a synthesis gas, and a fuel gas and an oxidizing gas undergo an electrochemical reaction inside a cell to generate electricity. During the reaction, most of combustible components are converted into electricity and heat. However, unconverted combustible components are discharged with a tail gas from a cell anode and still need to enter a combustion chamber for catalytic combustion. This not only increases complexity of system operation and causes additional economic burden, but also fails to avoid subsequent CO₂ emission problems, causing that CO₂ still needs to be captured and stored.

Therefore, the prior art still needs to be improved and developed.

### SUMMARY

In view of the above-mentioned defects of the prior art, a purpose of the present disclosure is to provide a zero-carbon-emission coal power-generation system capable of self-generating CO₂ working medium and a power-generation method therefor, to solve the problem in the prior art that the unconverted combustible components of IGFC are discharged with the tail gas from the cell anode and still need to enter the combustion chamber for catalytic combustion, which not only increases complexity of system operation and causes additional economic burden, but also fails to avoid subsequent CO₂ emission problems, where CO₂ still needs to be captured and stored.

Technical solutions of the present disclosure are as follows.

In a first aspect of the present disclosure, a zero-carbon-emission coal power-generation system capable of self-generating CO₂ working medium is provided, including a coal gasification reactor, a desulfurization absorption tower, a condensation tank, a pressure swing adsorption device, a CO storage tank, a cell device, and a first connection pipeline;
where the coal gasification reactor is connected to the desulfurization absorption tower, the desulfurization absorption tower is connected to the condensation tank, the condensation tank is connected to the pressure swing adsorption device, and the pressure swing adsorption device is respectively connected to the CO storage tank and the cell device;
the coal gasification reactor is provided with a pulverized-coal inlet and a CO₂ inlet;
the cell device includes a load, a cathode chamber, an anode chamber, and an electrolyte layer arranged between the cathode chamber and the anode chamber, and the cell device is provided with an air inlet and a tail-gas outlet;
the first connection pipeline connects the tail-gas outlet of the cell device with the coal gasification reactor, and is configured to circulate a tail gas generated in the cell device to the coal gasification reactor.

Optionally, a waste-heat recovery device is arranged between the coal gasification reactor and the cell device, and is configured to supply waste heat of an outflow gas of the cell device to the coal gasification reactor.

Optionally, the zero-carbon-emission coal power-generation system capable of self-generating CO₂ working medium further includes a second connection pipeline connecting the coal gasification reactor with the pressure swing adsorption device, and the second connection pipeline is configured to return CO₂ separated by the pressure swing adsorption device back into the coal gasification reactor.

Optionally, an air outlet is arranged at the cell device, and is configured to discharge lean-oxygen air generated by the cell device.

Optionally, the zero-carbon-emission coal power-generation system capable of self-generating CO₂ working medium further includes a residue storage tank, an ash-content discharge valve is arranged at a lower end of the coal gasification reactor, and the residue storage tank is connected to the ash-content discharge valve.

Optionally, the zero-carbon-emission coal power-generation system capable of self-generating CO₂ working medium further includes a preheating tank, the preheating tank is connected to the CO₂ inlet arranged at the coal gasification reactor, and the preheating tank is configured to preheat CO₂.

Optionally, an operation temperature of the coal gasification reactor is 720-1000 ° C, an operation temperature of the cell device is 720-1000 °C, and the operation temperature of the cell device is 20-50 °C higher than the operation temperature of the coal gasification reactor.

Optionally, an operation temperature of the condensation tank is 30-60 °C.

In a second aspect of the present disclosure, a power-generation method for the zero-carbon-emission coal power-generation system capable of self-generating CO₂ working medium is provided, including following steps:
adding coal into the coal gasification reactor through the pulverized-coal inlet and introducing CO₂ into the coal gasification reactor through the CO₂ inlet, where a gas containing CO is generated through a reaction in the coal gasification;
desulfurizing the generated gas containing CO by the desulfurization absorption tower to obtain a desulfurized gas, then condensing the desulfurized gas by the condensation tank, and then separating the CO into two parts by the pressure swing adsorption device, where one part of the CO is introduced into the CO storage tank for storage, and an other part of the CO is introduced into the cell device; and,
turning on the load of the cell device and introducing air into the cell device through the air inlet, where oxygen in the air obtains electrons in the cathode chamber to generate O²⁻, the generated O²⁻ is conducted from the cathode chamber to the anode chamber through the electrolyte layer, the O²⁻ undergoes an electrochemical reaction with CO in the anode chamber to generate CO₂ and to release electrons at the same time to form a closed circuit to generate current, and the generated CO₂ is circularly returned back into the coal gasification reactor through the first connection pipeline.

Optionally, operation parameters of the load include: a voltage of a single cell of 0.6 to 0.9V, and a current density of the single cell of 500 to 900 mA/cm².

Beneficial effects: in the zero-carbon-emission coal power-generation system capable of self-generating CO₂ working medium provided by the present disclosure, the desulfurization absorption tower for desulfurizing CO generated by a coal gasification reaction is arranged between the coal gasification reactor and the cell device, thereby avoiding a poisoning effect of a small amount of sulfur-containing gas contained in solid carbon after gasification on an anode catalyst. The condensation tank is provided to condense desulfurized CO to a suitable temperature, thereby ensuring separation of impurities such as moisture and light hydrocarbons, while maintaining a gaseous state of CO. The pressure swing adsorption device is provided to separate CO, one part of the CO is recovered and stored in the CO storage tank after pressure swing separation to obtain a high-purity and high-yield CO chemical product, and the other part of the CO enters the cell device to undergo an electrochemical reaction to generate CO₂ and to release electrons to generate current. The generated CO₂ and unconverted CO both in the cell device can reenter the coal gasification reactor through the first connection pipeline to participate in the coal gasification reaction. The power-generation system of the present disclosure not only has high power-generation efficiency and good power-generation stability, but also avoids subsequent CO₂ capture and storage by self-circulation of the system, thereby achieving near-zero emission of CO₂, and simultaneously co-producing value-added chemical product CO.

### BRIEF DESCRIPTION OF DRAWINGS

FIG. 1 is a schematic structural diagram of a zero-carbon-emission coal power-generation system capable of self-generating CO₂ working medium provided by the present disclosure.

FIG. 2 is a working-principle diagram of the zero-carbon-emission coal power-generation system capable of self-generating CO₂ working medium provided by the present disclosure.

FIG. 3 is a flow chart of a power-generation method for the zero-carbon-emission coal power-generation system capable of self-generating CO₂ working medium provided by the present disclosure.

FIG. 4 is a curve showing a power-generation durability test for the power-generation system provided in Embodiment 1 under conditions of a current density of 687 mA/cm² and an operation temperature of a cell device of 850 °C.

### DETAILED DESCRIPTION OF EMBODIMENTS

The present disclosure provides a zero-carbon-emission coal power-generation system capable of self-generating CO₂ working medium and a power-generation method therefor. In order to make purposes, technical solutions, and effects of the present disclosure clearer and more specific, the present disclosure is further described in detail below. It should be understood that the embodiments described herein are only used to explain the present disclosure and are not used to limit the present disclosure.

In the prior art, the unconverted combustible components of IGFC are discharged with the tail gas of the cell anode and still need to enter the combustion chamber for catalytic combustion, which not only increases complexity of system operation and causes additional economic burden, but also fails to avoid subsequent CO₂ emission problems, where CO₂ still needs to be captured and stored. In order to solve the above-mentioned problems, the present disclosure provides a zero-carbon-emission coal power-generation system capable of self-generating CO₂ working medium.

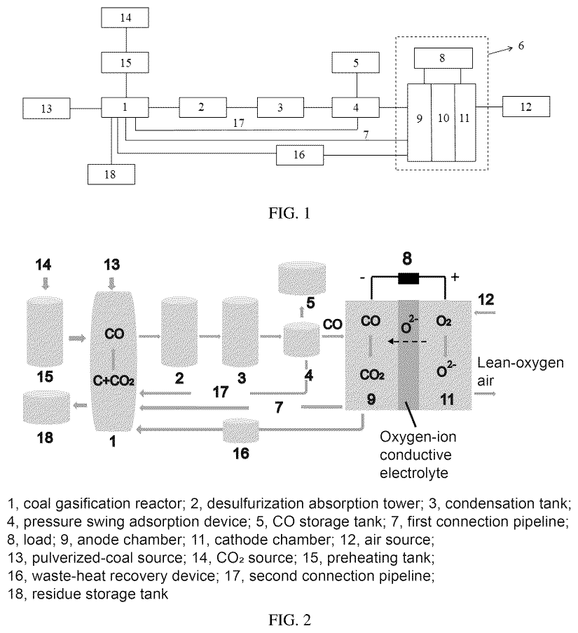

As shown in FIG. 1, an embodiment of the present disclosure provides a zero-carbon-emission coal power-generation system capable of self-generating CO₂ working medium, including: a coal gasification reactor 1, a desulfurization absorption tower 2, a condensation tank 3, a pressure swing adsorption device 4, a CO storage tank 5, a cell device 6, and a first connection pipeline 7.

The coal gasification reactor 1 is connected to and communicates with the desulfurization absorption tower 2, the desulfurization absorption tower 2 is connected to and communicates with the condensation tank 3, the condensation tank 3 is connected to and communicates with the pressure swing adsorption device 4, the pressure swing adsorption device 4 is connected to and communicates with the CO storage tank 5 and the cell device 6, respectively.

The coal gasification reactor 1 is provided with a pulverized-coal inlet and a CO₂ inlet. The pulverized-coal inlet is configured to add pulverized coal into the coal gasification reactor 1, and the pulverized coal is provided by a pulverized-coal source 13. The CO₂ inlet is configured to introduce CO₂ into the coal gasification reactor 1, and the CO₂ is provided by a CO₂ source 14.

The cell device 6 includes a load 8, a cathode chamber 11, an anode chamber 9, and an electrolyte layer 10 arranged between the cathode chamber 11 and the anode chamber 9. The cell device 6 is provided with an air inlet and a tail-gas outlet. The air inlet is configured to introduce air into the cell device 6, and the air is provided by an air source 12.

The first connection pipeline 7 makes the tail-gas outlet of the cell device 6 and the coal gasification reactor 1 connected together and communicate with each other, and the first connection pipeline 7 is configured to circulate tail gas generated in the cell device 6 to an inside of the coal gasification reactor 1.

The zero-carbon-emission coal power-generation system capable of self-generating CO₂ working medium provided in the present embodiment of the present disclosure, by arranging the desulfurization absorption tower 2 for desulfurizing CO generated by a coal gasification reaction between the coal gasification reactor 1 and the cell device 6, can avoid a poisoning effect of a small amount of sulfur-containing gas contained in solid carbon after gasification on anode catalyst. The system, by providing the condensation tank 3 to condense desulfurized CO to a suitable temperature, can ensure separation of impurities such as moisture and light hydrocarbons while maintaining a gaseous state of CO. In the system, the pressure swing adsorption device 4 is provided to separate CO, one part of the CO is recovered and stored in the CO storage tank 5 after pressure swing separation to obtain a high-purity and high-yield CO chemical product, and the other part of the CO enters the cell device 6 to undergo an electrochemical reaction to generate CO₂ and to release electrons to generate current. The generated CO₂ and unconverted CO both in the cell device 6 can reenter the coal gasification reactor 1 through the first connection pipeline 7 to participate in the coal gasification reaction. The power-generation system of the present disclosure not only has high power-generation efficiency and good power-generation stability, but also avoids subsequent CO₂ capture and storage through self-circulation of the system, achieves near-zero emission of CO₂, and simultaneously co-produces value-added chemical product CO.

The zero-carbon-emission coal power-generation system capable of self-generating CO₂ working medium provided in the embodiments of the present disclosure has a compact structure and a small pipeline loss in gas transmission. Heat generated by the electrochemical reaction in the cell device can heat the coal gasification reactor through cavity heat conduction, thermal radiation, etc., to supplement heat required for a reverse Boudouard reaction. No external heating is required, and the power-generation efficiency of the system can be improved.

The zero-carbon-emission coal power-generation system capable of self-generating CO₂ working medium provided in the embodiments of the present disclosure adopts a self-catalytic carbon-oxygen decoupling method to realize the co-production of power generation and CO. CO₂ generated in the anode chamber is circulated to the inside of the coal gasification reactor outside the cell device, and is spontaneously participated in a reduction reaction to regenerate oxidized reactants in an anode through a Boudouard formula. The system decouples an electrochemical oxidation reaction of CO from a non-electrochemical reduction reaction of CO₂ to realize continuous and stable circulation of reactants and to collect high-yield CO as a byproduct at the same time.

A working principle of the zero-carbon-emission coal power-generation system capable of self-generating CO₂ working medium provided in the embodiments of the present disclosure is as follows. As shown in FIG. 1 and FIG. 2, the pulverized coal is added to the coal gasification reactor 1 through the pulverized-coal source 13, and CO₂ gas is introduced into the coal gasification reactor 1 through the CO₂ source 14. The coal and the CO₂ both in the coal gasification reactor 1 undergo the reverse Boudouard reaction: C+CO₂=2CO, thereby generating a large amount of CO fuel gas. The generated CO can be desulfurized by the desulfurization absorption tower 2, which means that the CO generated in the coal gasification reactor 1 can be desulfurized, so as to avoid both the poisoning effect of a small amount of sulfur-containing gas contained in the pulverized coal after gasification on the anode catalyst and the sulfur-containing gas's blockage of pipelines after low-temperature solidification. All desulfurized CO is condensed to a suitable temperature by the condensation tank 3, which can ensure separation of impurities such as moisture, light hydrocarbons, etc. while maintaining the gaseous state of CO. One part of all condensed CO that has high purity is recovered and stored in the CO storage tank 5 after pressure swing separation by the pressure swing adsorption device 4, and the other part of the condensed CO enters the cell device 6. O₂ in air introduced by the air source 12 enters the cathode chamber 11 of the cell device 6 to obtain electrons to generate O²⁻. O²⁻ passes through the electrolyte layer 10 and enters the anode chamber 9, and reacts electrochemically with CO inside the anode chamber 9 to release electrons to an external circuit and to generate CO₂ at the same time. The generated CO₂ is circularly returned back to the inside of the coal gasification reactor 1 through the first connection pipeline 7. The power-generation system of the present disclosure avoids subsequent CO₂ capture and storage through self-circulation of the system, and achieves near-zero emission of CO₂.

In some implementations, the coal gasification reactor 1 generates a fuel gas through the coal gasification reaction, and a main component of the fuel gas is CO. The fuel gas further includes CO₂, N₂, H₂, CH₄, C₂H₆, C₂H₄, etc. Further, the components of the fuel gas are: CO: 70%, CO₂: 10%, N₂: 5%, H₂: 6%, CH₄: 3%, C₂H₆: 3%, and C₂H₄: 3%.

In some implementations, the zero-carbon-emission coal power-generation system capable of self-generating CO₂ working medium is provided with the CO₂ source 14 connected to and communicating with the coal gasification reactor 1, which is configured to introduce CO₂ into the coal gasification reactor 1, thereby achieving a supply of CO₂.

In some implementations, the zero-carbon-emission coal power-generation system capable of self-generating CO₂ working medium further includes a preheating tank 15, which is connected to and communicates with the CO₂ inlet provided on the coal gasification reactor 1, and is configured to preheat the CO₂ provided by the CO₂ source 14. The CO₂ is preheated by the preheating tank 15 and then introduced into the coal gasification reactor 1, which can accelerate reaction process of coal and CO₂ both in the coal gasification reactor.

In some implementations, an operation temperature of the preheating tank 15 is 500 °C to 750 °C, for example, 500 °C, 550 °C, 600 °C, 650 °C, 700 °C, 750 °C, etc.

In some implementations, the zero-carbon-emission coal power-generation system capable of self-generating CO₂ working medium is provided with the pulverized-coal source 13 connected to and communicating with the coal gasification reactor 1, which is configured to add the pulverized coal to the coal gasification reactor 1, so as to realize circulation and continuous supply of coal. When the power-generation system is operating, power generation of the cell device can be controlled by controlling an addition rate and a quantity of the pulverized coal. When a demand for electricity is small, the cell device operates at a lower current; at this time, the generation rate of CO can be controlled by decreasing the rate or the quantity of pulverized coal to decrease an electrochemical reaction rate, thereby decreasing output power. Conversely, when the demand for electricity is large, the quantity or the rate of the pulverized coal can be increased. Since the generation rate of CO is determined by the pulverized coal and the quantity of introduced CO₂ at the same time, the electrochemical reaction rate can be decreased by decreasing a circulated tail-gas CO₂ flow rate or the electrochemical reaction rate can be increased by increasing the circulated tail-gas CO₂ flow rate.

In some implementations, the zero-carbon-emission coal power-generation system capable of self-generating CO₂ working medium is further provided with a residue storage tank 18 connected to and communicating with the coal gasification reactor 1, and an ash-content discharge valve is provided at a lower end of the coal gasification reactor 1. The residue storage tank 18 is connected to and communicates with the ash-content discharge valve. Non-combustible coal ash-content particles and unburned coal particles both in the coal gasification reactor 1 are settled in the residue storage tank 18 through the ash-content discharge valve.

In some implementations, the pulverized-coal source 13 in the zero-carbon-emission coal power-generation system capable of self-generating CO₂ working medium is arranged at an upper end of the coal gasification reactor 1, and the residue storage tank 18 is arranged at the lower end of the coal gasification reactor 1. By arranging the pulverized-coal source at the upper end of the coal gasification reactor and the residue storage tank at the lower end of the coal gasification reactor, a from-top-to-bottom pulverized-coal supply method and a discharge-port design (the ash-content discharge valve) of lower-part ash contents are adopted to ensure rapid and continuous supply of coal fuel, which can increase CO supply, decrease a stack CO-concentration loss, and avoid a mechanical damage that may be caused by direct contact between the cell anode and the coal particles.

In some implementations, the addition rate and the quantity of the pulverized coal added into the coal gasification reactor 1 can be determined according to both a power demand of the cell device and CO₂ circulation amount. In one implementation, the addition rate of pulverized coal is 0.05-0.5 kg/min.

In some implementations, the desulfurization absorption tower 2 is connected to and communicates with the coal gasification reactor 1 and the condensation tank 3, and can be filled with granular desulfurizers such as limestone, dolomite, or slaked lime to complete a desulfurization process, which can avoid the poisoning effect of a small amount of sulfur-containing gas contained in CO after the coal gasification reaction on the anode catalyst. For example, when the anode catalyst is Ni particles, it can be avoided that the sulfur-containing gas causes the catalyst Ni particles to be sulfided to form NiS, Ni₃Sₓ and other low-catalytic-activity substances. The desulfurization absorption tower 2 may adopt a fixed-bed adsorption structure. Zinc oxide (ZnO) and iron oxide (Fe₂O₃) are filled in the tower as main adsorption materials, and the desulfurization absorption tower 2 operates in a temperature range of 300 to 500° C., which can effectively remove sulfides such as H₂S and SO₂ generated by the coal gasification reaction. The ZnO is mainly configured to adsorb H₂S for reacting to generate ZnS, and the Fe₂O₃ can react with H₂S to generate Fe₂S₃ and can be regenerated under certain conditions.

In some implementations, the condensation tank 3 is connected to and communicates with the desulfurization absorption tower 2 and the pressure swing adsorption device 4. Condensation can be achieved by shell-and-tube water-cooled condensation, a plate heat exchanger, etc. An operation temperature of the condensation tank 3 is 30-60 °C (for example, 30 °C, 35 °C, 40 °C, 45 °C, 50 °C, 55 °C, 60 °C, etc.) to ensure separation of a small amount of water, light hydrocarbons, and other impurities contained in CO, while maintaining the gaseous state of CO, so that a subsequent process can be performed by the pressure swing adsorption device to recover high-purity CO. A range of the operation temperature can remove water vapor and other impurities in gas without condensing carbon monoxide itself, which can ensure subsequent separation and recovery of gas, while ensuring an efficient operation of the system.

In some implementations, the pressure swing adsorption (PSA) device 4 is connected to and communicates with the condensation tank 3, and is connected to and communicates with the CO storage tank 5 and the cell device 6. Pressure swing adsorption is a technology that separates gases by periodic changes in pressure based on a difference in adsorption capacity of different components in a gas mixture on an adsorbent. In the embodiment of the present disclosure, the pressure swing adsorption device 4 recovers and stores high-purity CO in the CO storage tank 5 after performing the pressure swing separation for one part of condensed CO, and the other part of the condensed CO enters the cell device 6 and reacts electrochemically with O²⁻ in the anode chamber. In one implementation, 50% to 70% of the CO is controlled to be introduced into the CO storage tank 5 for recovery and storage, and the remaining CO (30% to 50%) is introduced into the cell device for the electrochemical reaction.

In some implementations, the zero-carbon-emission coal power-generation system capable of self-generating CO₂ working medium further includes a second connection pipeline 17 that makes the coal gasification reactor 1 and the pressure swing adsorption device 4 connected together and communicate with each other. The second connection pipeline 17 is configured to return CO₂ separated by the pressure swing adsorption device 4 back into the coal gasification reactor 1 to continue to participate in the coal gasification reaction, thereby further improving a utilization ratio of CO₂ and achieving near-zero emission of CO₂.

In some implementations, the cell device 6 includes the load 8, the cathode chamber 11, the anode chamber 9, and the electrolyte layer 10 that is arranged between the cathode chamber and the anode chamber. The anode of the cell device is a composite porous anode of electrolyte powder and Ni that is adopted by conventional solid oxide fuel cells. The electrolyte layer adopts commonly-used cationic electrolytes such as 8mol % Y₂O₃—ZrO₂, Ce_{0.8}Sm_{0.2}O_{1.9}, and Ce_{0.8}Gd_{0.2}O_{1.9}. The cathode of the cell device adopts a composite porous electrode of the above-mentioned electrolyte materials and a classical cathode material that is commonly used in the solid oxide cells, such as (La_{0.8}Sr_{0.2})_{0.95}MnO₃, (La_{0.6}Sr_{0.4})_{0.95}Co_{0.2}Fe_{0.8}O₃, etc.

In the present embodiment, a working principle of the cell device 6 is: when an external load is connected, air is provided by the air source 12, and oxygen in the air entering the cell device 6 obtains electrons from the cathode chamber 11 of the cell to become O²⁻. O²⁻ passes through the electrolyte layer 10 (optionally oxygen-ion conductive electrolyte) driven by a concentration difference and an electric potential difference to reach the anode chamber 9 of the cell. O²⁻ contacts a carbon monoxide gas in the anode chamber to undergo the electrochemical reaction to release electrons and to generate CO₂, thereby completing power generation. The coal gasification reaction and the electrochemical reaction are respectively carried out in the coal gasification reactor 1 and the cell device 6, which can realize circulation and continuous supply of coal. The pulverized coal does not directly contact a cell, avoiding the contact between coal particles and the anode and the contact between ash contents and the anode, and improving long-term stability of the cell.

In some implementations, the cell device 6 is further provided with an air outlet, and the air outlet is configured to discharge lean-oxygen air generated by the cell device. The lean-oxygen air in the cell device can be discharged to outside by providing a gas-discharge valve or a gas diverter, etc. in the cell device. In one implementation, the air inlet and air outlet both on the cell device 6 are arranged at the cathode chamber, and oxygen in air introduced through the air inlet obtains electrons in the cathode chamber to become O²⁻. lean-oxygen air can be discharged into the air through the air outlet, thereby increasing air circulation in the cell device, which is conducive to accelerating the electrochemical reaction.

In some implementations, a flow ratio of introduced CO to introduced air in the cell device 6 is generally controlled between 1:1 and 1:3 to ensure reaction efficiency while avoiding catalyst poisoning.

In some implementations, an operation voltage of the cell device 6 is 0.7-0.9V.

In some implementations, an operation temperature of the coal gasification reactor is 720-1000 °C (for example, 720 °C, 750 °C, 800 °C, 827 °C, 850 °C, 900 °C, 950 °C, 1000 °C, etc.), and an operation temperature of the cell device is 720-1000 °C (for example, 720 °C, 750 °C, 800 °C, 850 °C, 900 °C, 950 °C, 1000 °C, etc.), so as to avoid affecting long-term stability of the entire power-generation system due to an excessive temperature. The operation temperature of the cell device is 20-50 °C (23 °C in one implementation) higher than the operation temperature of the coal gasification reactor, so that a CO production rate of the coal gasification reactor 1 matches a CO consumption rate of the cell device 6, and heat generated by the cell device 6 is transferred to the coal gasification reactor 1 through a waste-heat recovery device 16 to maintain the operation temperature of the coal gasification reactor 1.

In some implementations, the waste-heat recovery device 16 (generally a tubular heat exchanger) is provided between the coal gasification reactor 1 and the cell device 6 in the zero-carbon-emission coal power-generation system capable of self-generating CO₂ working medium, and the waste-heat recovery device 16 is configured to supply waste heat of an outflow gas of the cell device 6 to the coal gasification reactor. In one implementation, the waste-heat recovery device 16 is connected to and communicates with the anode chamber 9 of the cell device 6 through a pipeline. Since a CO₂ tail gas enriched in the anode chamber 9 of the cell device 6 in the present embodiment is rich in CO₂ and has a high temperature, not only CO₂ can be recovered but also waste heat of CO₂ can be used to maintain the operation temperature of the coal gasification reactor 1, thereby improving energy utilization.

In some implementations, a temperature of an outlet of a pipeline of the anode chamber 9 of the cell device 6 is 700-900 °C, where the pipeline is connected to the waste-heat recovery device 16. The waste-heat recovery device 16 can transfer heat to the coal gasification reactor 1 to maintain the operation temperature of the coal gasification reactor 1.

In some implementations, in order to ensure that CO generated in the coal gasification reactor 1 only flows to an inside of the cell device and does not flow into other places to cause energy waste, the coal gasification reactor 1, the desulfurization absorption tower 2, the condensation tank 3, the pressure swing adsorption device 4, the CO storage tank 5, the cell device 6, and the first connection pipeline 7, as well as connection points thereof in the embodiment of the present disclosure are sealed and connected by high-temperature sealant. An operation temperature of the high-temperature sealant must be higher than the operation temperature of the cell device. In one implementation, the high-temperature sealant is high-temperature glass sealant that is resistant to 1250 °C.

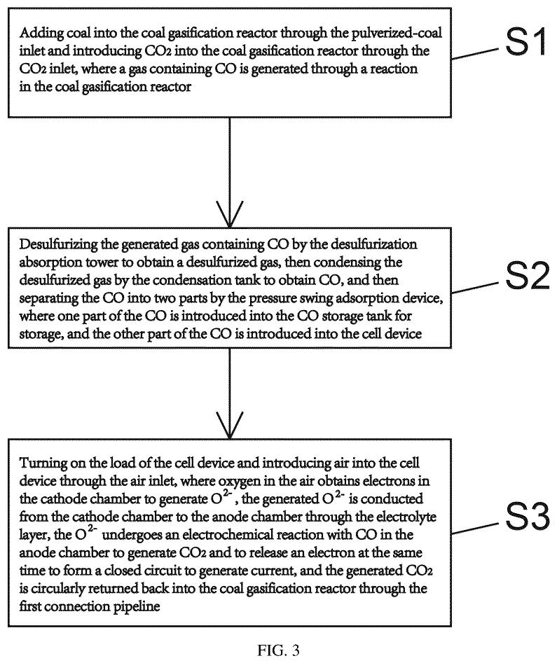

As shown in FIG. 3, an embodiment of the present disclosure provides a power-generation method for the zero-carbon-emission coal power-generation system capable of self-generating CO₂ working medium as described in any of the above embodiments. The method includes following steps:
S1, adding coal into the coal gasification reactor through the pulverized-coal inlet and introducing CO₂ into the coal gasification reactor through the CO₂ inlet, where a gas containing CO is generated through a reaction in the coal gasification reactor;
S2, desulfurizing the generated gas containing CO by the desulfurization absorption tower to obtain a desulfurized gas, then condensing the desulfurized gas by the condensation tank, and then separating the CO into two parts by the pressure swing adsorption device, where the one part of the CO is introduced into the CO storage tank for storage, and the other part of the CO is introduced into the cell device; and,
S3, turning on the load of the cell device and introducing air into the cell device through the air inlet, where oxygen in the air obtains electrons in the cathode chamber to generate O²⁻, the generated O²⁻ is conducted from the cathode chamber to the anode chamber through the electrolyte layer, the O²⁻ undergoes an electrochemical reaction with CO in the anode chamber to generate CO₂ and to release electrons at the same time to form a closed circuit to generate current, and the generated CO₂ is circularly returned back into the coal gasification reactor through the first connection pipeline.

In the present embodiment, the coal is added into the coal gasification reactor through the pulverized-coal inlet and the CO₂ is introduced into the coal gasification reactor through the CO₂ inlet. The coal gasification reaction is carried out in the independent coal gasification reactor. The coal and the CO₂ both in the coal gasification reactor undergo the reverse Boudouard reaction to generate CO, and then the gas containing CO is generated in the coal gasification reactor 1. The gas containing CO is desulfurized by the desulfurization absorption tower, then condensed by the condensation tank, and then separated into two parts by the pressure swing adsorption device to obtain CO. The one part of the CO is introduced into the CO storage tank for storage to obtain a high-purity and high-yield CO chemical product, and the other part of the CO is introduced into the cell device. The load of the cell device is turned on, and air is introduced into the cell device through the air inlet, where the oxygen in the air obtains electrons in the cathode chamber to generate O²⁻, the generated O²⁻ is conducted from the cathode chamber to the anode chamber through the electrolyte layer, and the O²⁻ undergoes the electrochemical reaction with the introduced CO in the anode chamber to generate CO₂ and to release electrons, forming the closed circuit to generate current, that is, completing power generation. The generated CO₂ is circulated to the coal gasification reactor through the first connection pipeline for further recovery and utilization.

In some implementations, operation parameters of the load include: a voltage of a single cell of 0.6 to 0.9V, and a current density of the single cell of 500 to 900 mA/cm².

In some implementations, pressure in the cell device is 1 to 100 atm.

In some implementations, reaction pressure of the coal gasification reactor is 1 to 100 atm.

In some implementations, a CO₂ conversion rate in the coal gasification reactor is 71.8% to 98%.

In some implementations, a CO conversion rate in the zero-carbon-emission coal power-generation system capable of self-generating CO₂ working medium is 70% to 95%.

In some implementations, in step S2, the CO is separated into two parts by the pressure swing adsorption device, 50% to 70% of the CO is introduced into the CO storage tank for storage, and the remaining CO is introduced into the cell device.

The present disclosure is further described below by means of an embodiment.

### Embodiment 1

The present embodiment provides the zero-carbon-emission coal power-generation system capable of self-generating CO₂ working medium and the power-generation method therefor.

As shown in FIG. 1, the CO₂ gas is introduced at a rate of 0.1 m³/s by the CO₂ source 14, and the CO₂ gas is preheated at 650 °C in the preheating tank 15 and then introduced into the coal gasification reactor 1 through the CO₂ inlet. The pulverized coal is provided by the pulverized-coal source 13, and the pulverized coal is added into the coal gasification reactor 1 through the pulverized-coal inlet at a rate of 0.2 kg/min. The pulverized coal and the CO₂ gas both in the coal gasification reactor 1 undergo the reverse Boudouard reaction at 800 °C: C+CO₂=2CO, thereby generating a gas containing CO in the coal gasification reactor 1. In addition, non-combustible coal ash-content particles and unburned pulverized-coal particles both in the coal gasification reactor 1 are settled in the residue storage tank 18 through the ash-content discharge valve provided at the lower end of the coal gasification reactor 1.

Subsequently, the gas containing CO generated in the coal gasification reactor 1 is desulfurized by the desulfurization absorption tower 2. The desulfurization absorption tower 2 adopts the fixed-bed adsorption structure, is filled with ZnO and Fe₂O₃ both as main adsorption materials, and operates in the temperature range of 300-500 °C to effectively remove sulfides such as H₂S and SO₂ generated by the coal gasification reaction. The desulfurized gas enters the shell-and-tube water-cooled condensation tank 3 (steam flows in a tube and cooling water flows outside the tube) through a gas outlet and then is condensed to 50 °C to ensure the CO-gas purity and improve the stability and service life of the subsequent cell device 6. Then, the condensed gas is introduced into the pressure swing adsorption device 4, in which an activated-carbon adsorbent is used. CO₂ is selectively adsorbed by PSA under high pressure, and regenerated by desorption at low pressure to achieve CO₂ separation and obtain a high-purity CO gas. 70% of the CO is recovered and stored in the CO storage tank 5 after pressure swing separation by the pressure swing adsorption device 4, and 30% of the CO enters the cell device 6. At the same time, the CO₂ separated by the pressure swing adsorption device 4 returns back into the coal gasification reactor 1 through the second connection pipeline 17 to continue to participate in the coal gasification reaction.

The load 8 of the cell device 6 is turned on. At a current density of 687 mA/cm², a cell output voltage is stabilized at 0.78V. Air is introduced into the cell device 6 (its operation temperature is 850 °C) through the air source 12. The introduced air enters the cathode chamber 11, and oxygen in the air obtains electrons to generate O²⁻. The O²⁻ is conducted from the cathode chamber 11 to the anode chamber 9 through the electrolyte layer 10. The O²⁻ undergoes the electrochemical reaction with CO introduced into the anode chamber 9 to generate CO₂ and to release electrons to an external circuit at the same time, thereby forming the closed circuit to generate current. The generated CO₂ circularly returns back to the coal gasification reactor 1 through the first connection pipeline 7. At the same time, waste heat of a 750 °C gas flowing out of the cell device 6 is recovered and utilized by the waste-heat recovery device 16, and is supplied to the coal gasification reactor 1 to provide a temperature required for operation.

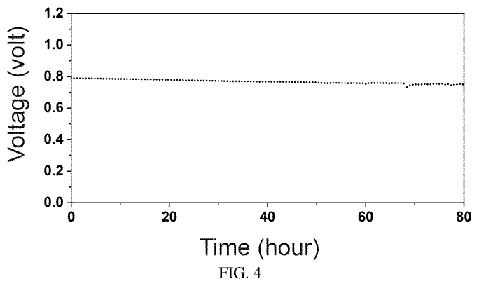

FIG. 4 is a curve showing a power-generation durability test for the power-generation system provided in Embodiment 1 under conditions of the current density of 687 mA/cm² and the operation temperature of the cell device of 850 °C. According to the FIG. 4, the power-generation system has no obvious voltage fluctuations during the power-generation process, shows good power-generation stability, and can generate power stably for more than 80 hours.

In summary, in the zero-carbon-emission coal power-generation system capable of self-generating CO₂ working medium provided by the present disclosure, the desulfurization absorption tower for desulfurizing the CO generated by the coal gasification reaction is arranged between the coal gasification reactor and the cell device, thereby avoiding the poisoning effect of a small amount of sulfur-containing gas contained in solid carbon after gasification on the anode catalyst. The condensation tank is provided to condense the desulfurized CO to a suitable temperature, thereby ensuring separation of impurities such as moisture and light hydrocarbons, while maintaining the gaseous state of CO. The pressure swing adsorption device is provided to separate CO, one part of the CO is recovered and stored in the CO storage tank after pressure swing separation to obtain a high-purity and high-yield CO chemical product, and the other part of the CO enters the cell device to undergo an electrochemical reaction to generate CO₂ and to release electrons to generate current. The generated CO₂ and unconverted CO both in the cell device can reenter the coal gasification reactor through the first connection pipeline to participate in the coal gasification reaction. The power-generation system of the present disclosure not only has high power-generation efficiency and good power-generation stability, but also avoids subsequent CO₂ capture and storage by self-circulation of the system, thereby achieving near-zero emission of CO₂, and simultaneously co-producing value-added chemical product CO.

It should be understood that applications of the present disclosure are not limited to the above embodiments. For those ordinary skilled in the art, improvements or changes can be made based on the above description. All these improvements and changes should fall within the protection scope of the claims attached to the present disclosure.

What is claimed is:

1. A zero-carbon-emission coal power-generation system capable of self-generating CO₂ working medium, the zero-carbon-emission coal power-generation system comprising:
a coal gasification reactor;
a desulfurization absorption tower;
a condensation tank;
a pressure swing adsorption device;
a CO storage tank;
a cell device; and
a first connection pipeline;
wherein the coal gasification reactor is connected to the desulfurization absorption tower, the desulfurization absorption tower is connected to the condensation tank, the condensation tank is connected to the pressure swing adsorption device, and the pressure swing adsorption device is respectively connected to the CO storage tank and the cell device;
the coal gasification reactor is provided with a pulverized-coal inlet and a CO₂ inlet;
the cell device comprises a load, a cathode chamber, an anode chamber, and an electrolyte layer arranged between the cathode chamber and the anode chamber, and the cell device is provided with an air inlet and a tail-gas outlet; and
the first connection pipeline connects the tail-gas outlet of the cell device with the coal gasification reactor, and is configured to circulate a tail gas generated in the cell device to the coal gasification reactor.

2. The zero-carbon-emission coal power-generation system capable of self-generating CO₂ working medium according to claim 1, wherein a waste-heat recovery device is arranged between the coal gasification reactor and the cell device, and is configured to supply waste heat of an outflow gas of the cell device to the coal gasification reactor.

3. The zero-carbon-emission coal power-generation system capable of self-generating CO₂ working medium according to claim 1, further comprising a second connection pipeline connecting the coal gasification reactor with the pressure swing adsorption device, and the second connection pipeline is configured to return CO₂ separated by the pressure swing adsorption device back into the coal gasification reactor.

4. The zero-carbon-emission coal power-generation system capable of self-generating CO₂ working medium according to claim 1, wherein an air outlet is arranged at the cell device, and is configured to discharge lean-oxygen air generated by the cell device.

5. The zero-carbon-emission coal power-generation system capable of self-generating CO₂ working medium according to claim 1, further comprising a residue storage tank, an ash-content discharge valve is arranged at a lower end of the coal gasification reactor, and the residue storage tank is connected to the ash-content discharge valve.

6. The zero-carbon-emission coal power-generation system capable of self-generating CO₂ working medium according to claim 1, further comprising a preheating tank, the preheating tank is connected to the CO₂ inlet arranged at the coal gasification reactor, and the preheating tank is configured to preheat CO₂.

7. The zero-carbon-emission coal power-generation system capable of self-generating CO₂ working medium according to claim 1, wherein an operation temperature of the coal gasification reactor is 720-1000 °C, an operation temperature of the cell device is 720-1000 °C, and the operation temperature of the cell device is 20-50 °C higher than the operation temperature of the coal gasification reactor.

8. The zero-carbon-emission coal power-generation system capable of self-generating CO₂ working medium according to claim 1, wherein an operation temperature of the condensation tank is 30-60 °C.

9. A power-generation method for the zero-carbon-emission coal power-generation system capable of self-generating CO₂ working medium according to claim 1, the method comprising steps of:
adding coal into the coal gasification reactor through the pulverized-coal inlet and introducing CO₂ into the coal gasification reactor through the CO₂ inlet, wherein a gas containing CO is generated through a reaction in the coal gasification reactor;
desulfurizing the generated gas containing CO by the desulfurization absorption tower to obtain a desulfurized gas, then condensing the desulfurized gas by the condensation tank, and then separating the CO into two parts by the pressure swing adsorption device, wherein one part of the CO is introduced into the CO storage tank for storage, and an other part of the CO is introduced into the cell device; and
turning on the load of the cell device and introducing air into the cell device through the air inlet, wherein oxygen in the air obtains electrons in the cathode chamber to generate O²⁻, the generated O²⁻ is conducted from the cathode chamber to the anode chamber through the electrolyte layer, the O²⁻ undergoes an electrochemical reaction with CO in the anode chamber to generate CO₂ and to release electrons at the same time to form a closed circuit to generate current, and the generated CO₂ is circularly returned back into the coal gasification reactor through the first connection pipeline.

10. The power-generation method for the zero-carbon-emission coal power-generation system capable of self-generating CO₂ working medium according to claim 9, wherein operation parameters of the load comprise: a voltage of a single cell of 0.6 to 0.9V, and a current density of the single cell of 500 to 900 mA/cm².
